(19) United States
(12) Patent Application Publication
(10) Pub. No.: US 2024/0100570 A1
(43) Pub. Date: Mar. 28, 2024

(54) DEVICE AND METHOD FOR CLEANING A COATING MATERIAL

(71) Applicant: HOMAG GmbH, Schopfloch (DE)

(72) Inventors: Steffen FINKBEINER, Baiersbronn (DE); Peter WULZINGER, Sulz a. N. (DE)

(21) Appl. No.: 18/275,186

(22) PCT Filed: Feb. 9, 2022
(86) PCT No.: PCT/EP2022/053111

§ 371 Date: Jul. 31, 2023

(30) Foreign Application Priority Data
Feb. 11, 2021 (DE) 10 2021 103 237.7

(51) Int. Cl. B08B 1/00; B05D 3/10; B08B 1/02; B08B 3/04

(52) U.S. Cl. CPC B08B 1/006; B05D 3/107; B08B 1/008; B08B 1/02; B08B 3/041; B05D 2201/00; B05D 2203/20

(57) ABSTRACT

Device (1) for cleaning a coating material (2), in particular a coating material (2) provided on a workpiece (4), the workpiece (4) preferably consisting at least in parts of wood, wood materials or plastic, comprising a cleaning element (10) for removing soilings from the coating material (2), a conveying unit (20) for causing a relative movement between the cleaning element (10) and the coating material (2), and a cleaning agent application unit (30, 30′) for applying a preferably liquid cleaning agent to the cleaning element (10).

### TECHNICAL FIELD

The invention relates to a device for cleaning a coating material according to the preamble of patent claim 1 as well as a method for cleaning a coating material using said device.

### PRIOR ART

In the field of the furniture and components industry, workpieces which, for example, consist of wood or wood materials, are often coated with a coating material in the area of their surface. This coating material may contain different patterns or be given different patterns in the course of further finishing.

For example, EP 2 065 217 A discloses a method for patterning workpieces, wherein printing units such as, for example, inkjet printers are used to provide the coating material with the desired pattern. In this respect, EP 2 065 217 A also discloses a treatment module for the material to be printed, which serves to preclean, degrease or improve the adhesion and wetting properties of the material to be printed.

The known devices have proven themselves in practice. However, it has become apparent that both the quality and durability of the patterning should be further improved. The inventors recognized that this can be achieved by improving the cleaning of the coating material.

### DESCRIPTION OF THE INVENTION

The object of the present invention is to provide a device for cleaning a coating material, in particular a coating material provided on a workpiece, which allows improved cleaning of the coating material and thus better preparation for subsequent finishing steps. Furthermore, it is an object of the invention to provide a corresponding method for cleaning a coating material.

According to the invention, this object is solved by a device for cleaning a coating material according to claim 1 and a method for cleaning a coating material according to claim 10. Particularly preferred further developments of the invention are specified in the dependent claims.

The invention is based on the idea of achieving effective cleaning of the coating material by a specific combination of two measures. On the one hand, a cleaning element is used to remove soilings from the coating material. On the other hand, the device comprises a cleaning agent application unit which is used to apply a preferably liquid cleaning agent to the cleaning element and thus to increase the cleaning performance of the cleaning element. Combining mechanical cleaning by the cleaning element on the one hand and chemical cleaning by the cleaning agent applied to the cleaning element on the other allows to achieve a cleaning performance that is significantly better than that of previous cleaning devices.

According to the invention, it is thus possible for the first time to remove even stubborn soilings and, for example, to completely remove soilings which are initially invisible to the naked eye. Fingerprints may be mentioned as an example, which may be made when handling the workpieces provided with the coating material. Such soilings are surprisingly difficult to remove; they can, however, significantly impair the results of subsequent finishing processes and, for example, seriously impair the quality and durability of a patterning. This is where the device according to the invention comes in and allows the effective and quick removal of different soilings of this type.

As a result, not only significantly better cleaning can thus be achieved but also high- quality and durable finishing (for example printing) of the coating material in subsequent steps, thus providing higher-quality workpieces.

According to a further development of the invention, it is provided that the device comprises a pressing unit with at least one pressing element for pressing the cleaning element against the coating material. This allows to further increase the cleaning performance, and the reliability of the cleaning operation can also be increased.

It is particularly preferred that at least one pressing element comprises, at least in the contact area with the cleaning element, an elastic material such as, in particular, an elastomer. This also allows the effective and thorough cleaning of coating materials having an irregular (for example, rounded) cross-section or unevenness since the elastic material, and thus also the cleaning element, can adapt to the shape of the coating material.

Alternatively or in addition, according to a further development of the invention, provision is made such that at least one pressing element is arranged so as to be moveable, and preferably at least one force application unit is provided for urging at least one pressing element towards the cleaning element. This allows to ensure a defined impact force of the pressing element, resulting in a uniform cleaning performance. Moreover, irregularities in the geometry or position of the coating material can be compensated while the cleaning performance remains constant.

According to a further development of the invention, it is also provided that the cleaning agent application unit has at least one discharge opening which is preferably provided in the area and/or upstream of the pressing unit. By integrating the at least one discharge opening in the area of the pressing unit, the cleaning agent can be applied to the respective cleaning element in a particularly targeted manner and without losses. The arrangement of a discharge opening upstream of the pressing unit also enables effective application of the cleaning agent but additionally also simplifies the construction of the cleaning agent application unit.

Within the scope of the present invention, the cleaning agent may be configured in many ways and, in principle, can also be gaseous and/or solid (e.g. in powder form). However, liquid cleaning agents have proven to be particularly effective, and according to a further development of the invention, it is provided that the cleaning agent application unit contains a cleaning agent with an evaporation number of at most 10 (according to DIN 53170 in the version which was valid on the filing date). In addition to the high cleaning performance, such a liquid and volatile cleaning agent has the advantage that residues of the cleaning agent volatilize very quickly from the surface of the coating material, with the result that the appearance is not impaired and, moreover, subsequent finishing processes (such as printing) can be started within a very short time. It is particularly preferred that the cleaning agent comprises at least 50% alcohol and/or at least 5% ketones and aldehydes. Such a cleaning agent combines good cleaning properties with a low evaporation number.

According to a further development of the invention, it is provided that the device comprises a feed unit for feeding at least one cleaning element. By this, it can be ensured that the cleaning element always has the required and desired cleaning performance, for example by feeding (in cycles and/or in a continuous manner) the cleaning element using the feed unit. The feed rate of the cleaning element can be adapted to various parameters such as the conveying speed of the workpieces provided with the coating material, the degree of soiling, the properties of the cleaning element, etc.

Within the scope of the invention, the cleaning element can be made of various materials, with an absorbent material having proven to be particularly advantageous. In the context of the invention, such an absorbent material is preferably selected from fabric, woven fabric, nonwoven and combinations thereof, and particularly preferably comprises cellulose. These materials have shown good cleaning performance and durability.

An apparatus for finishing a coating material with a device according to the invention is the subject matter of patent claim 9. In addition to the cleaning device according to the invention, this apparatus comprises a device for patterning, in particular printing, the cleaned coating material. In this apparatus, the cleaning device according to the invention can develop its advantages to a high degree. In particular, the cleaning device allows an optimum preparation of the coating material for the subsequent patterning process by means of the patterning device. As a result, coating materials or workpieces are obtained, the patterned surfaces of which have a particularly high quality and durability.

The aforementioned advantages can be realized in a particularly pronounced manner by means of a method for cleaning a coating material according to patent claim 10. Although these advantages are achieved for a wide variety of coating materials, the use of the cleaning method according to the invention has proven to be particularly advantageous with coating materials consisting at least in parts of plastic.

### BRIEF DESCRIPTION OF THE DRAWINGS

FIG. 1 schematically shows a plan view of an apparatus for finishing a coating material according to an embodiment of the invention;

FIG. 2 schematically shows a partial side view of the apparatus shown in FIG. 1;

FIG. 3 schematically shows a further embodiment of a device for cleaning a coating material according to the invention.

### DETAILED DESCRIPTION OF PREFERRED EMBODIMENTS

Preferred embodiments of the invention will be described in detail below with reference to the accompanying drawings.

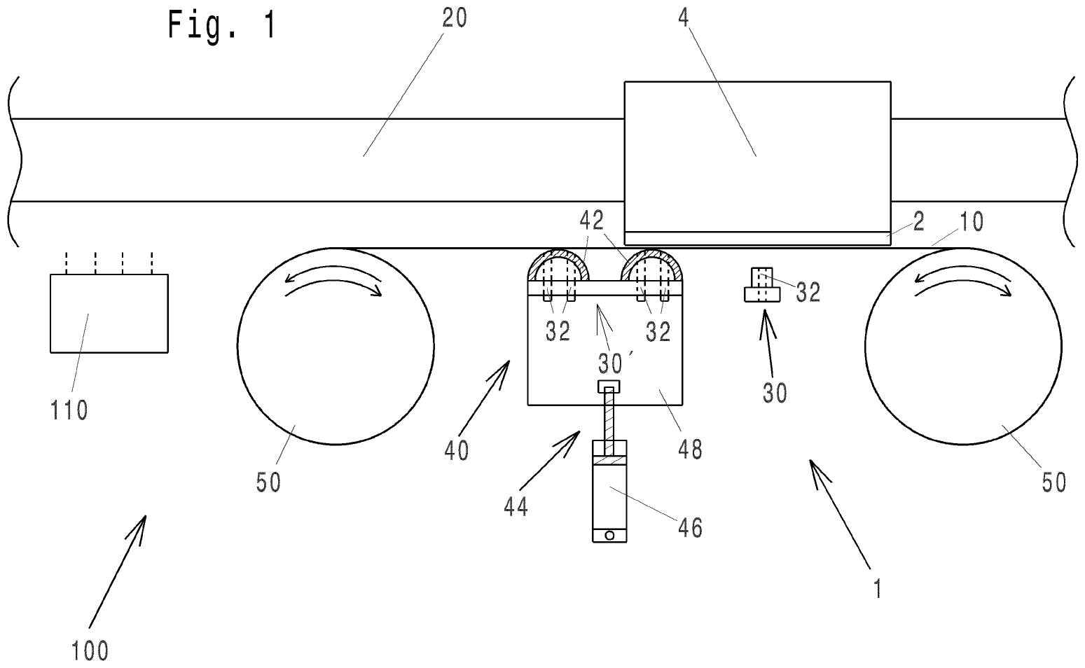

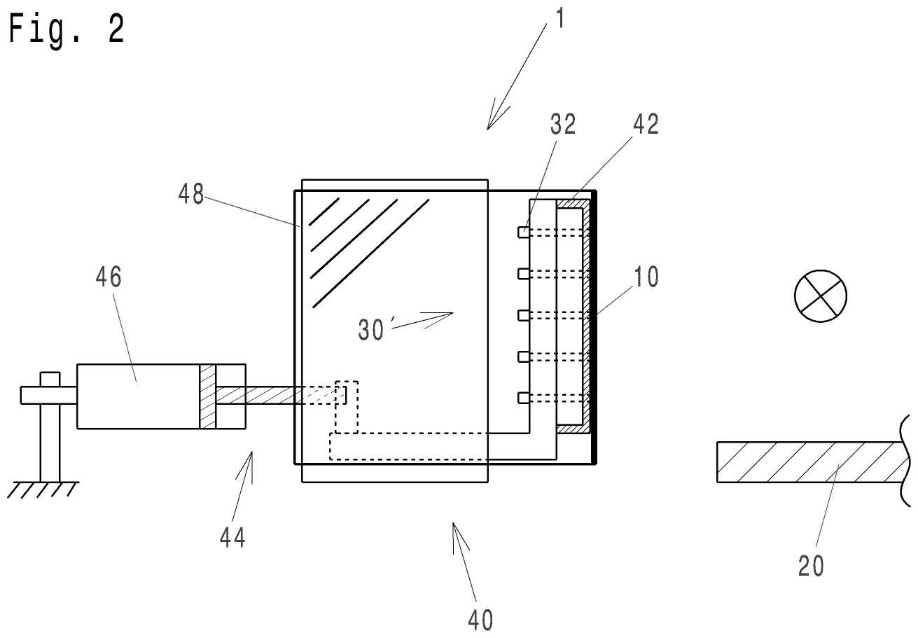

An apparatus 100 for finishing a coating material 2 according to an embodiment of the invention is shown schematically in FIGS. 1 and 2 in a plan view and a partial side view, respectively. The apparatus 100 is used for finishing a coating material 2 provided on a workpiece 4, which may consist of, for example, wood, wood materials, plastic or the like. Such workpieces are widely used in the field of the furniture and components industry, for example, furniture panels, tabletops, door panels or the like.

The apparatus 100 firstly comprises a printing device 110 which can be, for example, an inkjet printing device. This inkjet printing device is used to provide the coating material 2 with a desired pattern which, for example, can be matched to the other surfaces of the workpiece. Instead of a printing device, other suitable finishing devices can also be provided.

Upstream of the printing device 110, the apparatus 100 comprises a cleaning device 1 for cleaning the coating material 2 provided on the workpiece 4. The coating material may be, for example, a plastic edge that has been applied to a narrow surface of the workpiece 4. It should be noted, however, that the coating material 2 may also consist of other materials and that, in principle, any surfaces of the workpiece 4 may be provided with a coating material 2 to be cleaned.

Although not shown in the figures, the apparatus 100 may comprise, upstream of the cleaning device 1, a machine for machining and/or coating workpieces, the operation of which may be associated with the cleaning device 1, for example also by means of a common conveying unit for conveying the workpieces.

The cleaning device 1 first comprises a cleaning element 10 for removing soilings from the coating material 2, which in the present embodiment is configured as a band-shaped cleaning element. In the present embodiment, the band-shaped cleaning element 10 consists of an absorbent material containing cellulose, which is fed in cycles or in a continuous manner by means of a feed unit 50. As can be seen in FIG. 1, the feed unit 50 has in the present embodiment a feed roller (right in FIG. 1) and a take-up roller (left in FIG. 1). These may be driven, with it being possible to adjust the feed rate of the drive to various operating parameters of the device or other variables to ensure adequate cleaning performance of the cleaning element 10 at all times.

Furthermore, the cleaning device 1 comprises a conveying unit 20, which in the present embodiment is configured as a conveyor belt or a conveyor chain and is used to convey the coating material 2 along the cleaning element 10. However, it is to be noted that the conveying unit 20 may also be used to guide the cleaning element along an (optionally stationary) coating material 2, and that combinations of both types of movement and other types of movement are also possible.

Furthermore, the cleaning device 1 comprises, in the present embodiment, two cleaning agent application units 30 and 30′ for applying a cleaning agent to the cleaning element 10, which are described in more detail below.

Adjacent to the cleaning element 10, a pressing unit 40 is provided for pressing the cleaning element 10 against the coating material 2, which in the present embodiment comprises two pressing elements 42. In the present embodiment, the pressing elements 42 are formed as rounded projections having an elastomer in the contact area with the cleaning element 10 such as Vulkollan having a Shore D hardness of about 50. As a result hereof, a particularly good adaptation of the pressing element 42 or the cleaning element 10 acted upon thereby to the coating material can be achieved with a correspondingly high cleaning performance.

As can be seen in FIG. 1 and FIG. 2, the pressing elements 42 of the present embodiment are mounted on a common support 48, which is arranged so as to be moveable and can be moved in a direction perpendicular to the direction of extension of the cleaning element 10 by means of a (pneumatic) cylinder 46 or another suitable driving device. This allows a force application unit 44 to be formed which urges the pressing elements 42 towards the cleaning element 10 in order to press the cleaning element with a defined force on the coating material 2 to be cleaned. The force applied by the cylinder 46 can be suitably adjusted and can also be adapted, if required, during operation of the cleaning device 1.

As can be seen in FIG. 1, a first cleaning agent application unit 30 is provided upstream of the pressing unit 40. However, in the present embodiment, the cleaning device 1 additionally also comprises a cleaning agent application unit 30 provided in the area of the pressing unit 40. In some cases, a cleaning agent application unit may also be useful downstream of the pressing unit, for example if another pressing unit follows (to which the cleaning agent application unit in question is then again located upstream, or if the cleaning element downstream of the pressing unit is used to wipe other areas (such as corners and edges) of the coating material.

Both cleaning agent application units 30, 30′ each have at least one discharge opening 32 for cleaning agent, which faces the cleaning element 10 such that cleaning agent can be applied to the cleaning element 10 using the cleaning agent application units 30, 30′. The path for applying the cleaning agent can also extend through the pressing elements 42 (cf. FIG. 1).

In the present embodiment, the cleaning agent is a liquid cleaning agent containing at least 50% alcohol such as ethanol and at least 5% ketones and aldehydes such as acetone and having an evaporation number (according to DIN 53170 in the version that was valid on the filing date) considerably lower than 10. This results in a good cleaning performance without leaving interfering residues on the cleaned coating material 10.

For example, the operation of the system 100 according to the invention is performed as follows. A workpiece 4 provided with a coating material 2 is conveyed by the conveying unit 20 (from right to left in FIG. 1) and thereby comes into contact with the cleaning element 10. During this, the cleaning element 10 is impregnated with the liquid cleaning agent by means of the cleaning agent application units 30, 30′. In the further course, the coating material 2 reaches the pressing elements 42 and comes into a predefined cleaning contact with the cleaning element 10 which in this area is pressed with a predetermined force against the coating material 2 by means of the pressing elements 42. While doing so, a thorough and gentle cleaning of the coating material 2 is performed by a combination of mechanical cleaning by the cleaning element 10 and chemical cleaning by the cleaning agent applied to the cleaning element 10.

As soon as the coating material 2 is no longer in contact with the cleaning element 10, the cleaning agent remaining on the coating material 2 evaporates, with the result that finishing (e.g. printing) of the coating material 2 can be carried out immediately afterwards by the printing device 110.

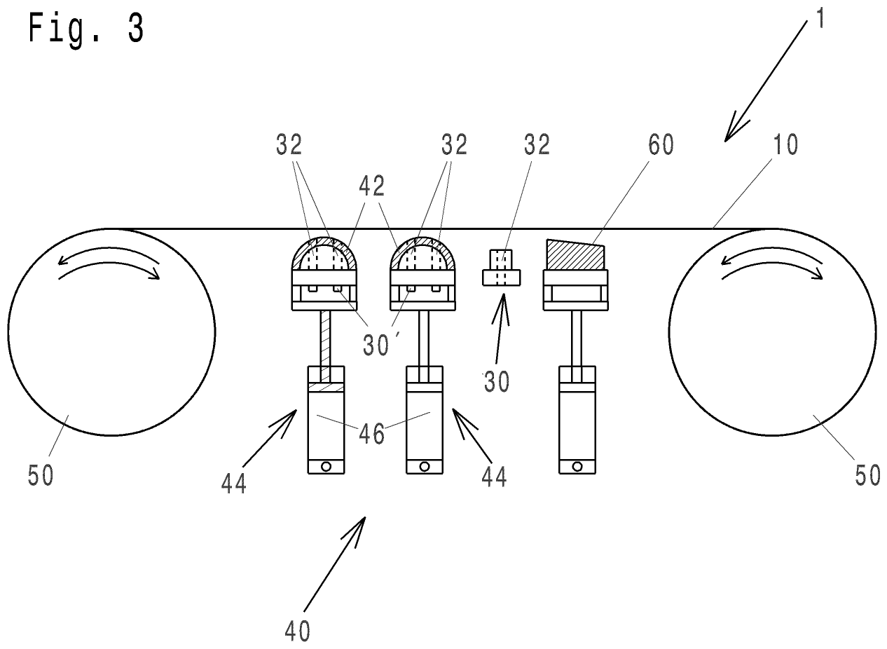

A further embodiment of the cleaning device 1 according to the invention is shown schematically in plan view in FIG. 3. This embodiment differs from the embodiment shown in FIG. 1 firstly in that a separate cylinder 46 is provided for each pressing element 42, with the result that the position and/or pressing force of the two pressing elements 42 can be controlled or adjusted independently of one another. This allows additional cleaning effects to be achieved such as gentle pre-cleaning and more intensive post-cleaning.

In addition, the embodiment of the cleaning device 1 shown in FIG. 3 comprises a damper 60 which is provided upstream of the pressing elements 42 and used to prevent a hard impact of a workpiece 4, which is conveyed on the conveying device 20, against the pressing elements 42. For this purpose, on its side facing the cleaning element 10, the damper has a beveled section which may be made of an elastic and shock-absorbing material. Moreover, as shown in FIG. 3, the damper 60 may be supported by a (pneumatic) cylinder to adjust its position and compliance.

Although not shown in the figures, the cleaning device 1 may also comprise a deflection device that allows both sides of the cleaning element 10 to be used for cleaning purposes. Alternatively or additionally, it is further possible to provide a washing-out unit for the cleaning element 10 such that it can be washed out (or otherwise cleaned) and reused after a cleaning operation.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. Device for cleaning a coating material, in particular a coating material provided on a workpiece, the workpiece preferably consisting at least in parts of wood, wood materials or plastic, comprising:
a cleaning element for removing soilings from the coating material,
a conveying unit for causing a relative movement between the cleaning element and the coating material, and
a cleaning agent application unit for applying a preferably liquid cleaning agent to the cleaning element.

2. Device according to claim 1, wherein a pressing unit is provided having at least one pressing element for pressing the cleaning element against the coating material.

3. Device according to claim 2, wherein at least one pressing element comprises, at least in the contact area with the cleaning element, an elastic material such as, in particular, an elastomer.

4. Device according to claim, wherein at least one pressing element is arranged so as to be moveable, and preferably at least one force application unit is provided for urging at least one pressing element towards the cleaning element.

5. Device according to claim 1, wherein the cleaning agent application unit has at least one discharge opening which is preferably provided in the area and/or upstream of the pressing unit.

6. Device according to claim 1, wherein the cleaning agent application unit contains a cleaning agent with an evaporation number of at most 10 and preferably comprising at least 50% alcohol and/or at least 5% ketones and aldehydes.

7. Device according to claim 1, wherein a feed unit is provided for feeding at least one cleaning element.

8. Device according to claim 1, wherein the cleaning element comprises an absorbent material which is preferably selected from fabric, woven fabric, nonwoven and combinations thereof, and particularly preferably comprises cellulose.

9. Apparatus for finishing a coating material, comprising:
a device for cleaning the coating material according to one of the preceding claims, and
a device) for patterning, in particular printing, the cleaned coating material.

10. Method for cleaning a coating material (2), in particular a coating material provided on a workpiece, the workpiece preferably consisting at least in parts of wood, wood materials or plastic, using a device for cleaning the coating material according to one of the preceding claims, and comprising the steps of:
causing a relative movement between a cleaning element and the coating material by means of the conveying unit,
applying a preferably liquid cleaning agent to the cleaning element by means of the cleaning agent application unit, and
removing soilings from the coating material by means of the cleaning element.

11. Method according to claim 10, wherein the coating material consists at least in parts of plastic.
